(19) United States
(12) Patent Application Publication
(10) Pub. No.: US 2024/0332754 A1
(43) Pub. Date: Oct. 3, 2024

(54) SECONDARY BATTERY AND METHOD FOR MANUFACTURING THE SAME

(71) Applicant: HONDA MOTOR CO., LTD., Tokyo (JP)

(72) Inventor: Toshiyuki ARIGA, Saitama (JP)

(21) Appl. No.: 18/586,548

(22) Filed: Feb. 26, 2024

(30) Foreign Application Priority Data
Mar. 31, 2023 (CN) 202310336162.1

(51) Int. Cl. H01M 50/54; H01M 4/02; H01M 4/134; H01M 10/0525; H01M 10/0585; H01M 50/109

(52) U.S. Cl. CPC H01M 50/54; H01M 4/134; H01M 10/0525; H01M 10/0585; H01M 50/109; H01M 2004/027

(57) ABSTRACT

A secondary battery of this invention includes: an electrode multilayer that includes a positive electrode layer, a negative electrode layer and a separator; an exterior case; a positive electrode tab and a negative electrode tab that are included in the exterior case; a positive electrode lead wire that electrically connects the positive electrode layer and the positive electrode tab; and a negative electrode lead wire that electrically connects the negative electrode layer and the negative electrode tab, the exterior case includes a cup-shaped formed member, the cup-shaped formed member includes a recess portion, the recess portion includes an electrode multilayer container, a positive electrode lead wire container and a negative electrode lead wire container and a width of the positive electrode lead wire container and a width of the negative electrode lead wire container are narrower than a width of the electrode multilayer.

This application is based on and claims the benefit of priority from Chinese Patent Application No. CN202310336162.1, filed on 31 Mar. 2023, the content of which is incorporated herein by reference.

### BACKGROUND OF THE INVENTION

### Field of the Invention

The present invention relates to a secondary battery and a method for manufacturing the secondary battery.

### Related Art

In recent years, research and development have been conducted on secondary batteries which contribute to energy efficiency in order to ensure more people have access to reliable, sustainable and advanced energy at an affordable price. In order to enhance the energy density of a secondary battery, a secondary battery is being considered that uses an electrode multilayer in which a plurality of positive electrode layers and negative electrode layers are alternately stacked via separators. In the secondary battery using the electrode multilayer, as an exterior case, a cup-shaped formed member including a recess portion and a flat portion connected to an edge of the recess portion is used, the electrode multilayer is contained in the recess portion and decompression sealing is performed (Patent Document 1). The positive electrode tab and the negative electrode tab of the secondary battery are arranged at the flat portion of the cup-shaped formed member, the electrode multilayer, and a positive electrode lead wire which connects the positive electrode layer of the electrode multilayer and the positive electrode tab and a negative electrode lead wire which connects the negative electrode layer and the negative electrode tab are contained in the recess portion of the cup-shaped formed member. The cup-shaped formed member is formed by drawing a laminate material.
Patent Document 1: Japanese Patent No. 6100035

### SUMMARY OF THE INVENTION

Incidentally, in technology related to secondary batteries, increasing the capacities thereof is an issue. In order to increase the capacity of the secondary battery, as a negative electrode active material, use of metallic lithium or silicon is being considered. In a secondary battery which uses metallic lithium or silicon as a negative electrode active material, a large change in the thickness of a negative electrode layer is caused by charging and discharging. Hence, the capacity of the secondary battery needs to be designed in accordance with a state where the thickness of the negative electrode layer has been increased so that the recess portion of the cup-shaped formed member of an exterior case is not damaged even when the thickness of the negative electrode layer is changed. It is also necessary to be able to follow a change in the thickness of the negative electrode layer by providing extra length portions in a positive electrode lead wire and a negative electrode lead wire so that the positive electrode lead wire and the negative electrode lead wire are not cut by tensile stress caused by a change in the thickness of the negative electrode layer. However, the negative electrode layer when the secondary battery is manufactured is in a discharged state, and thus the thickness thereof is thin. Hence, it is likely that by decompression sealing when the secondary battery is manufactured, the recess portion of the exterior case is partially deformed, and thus the positive electrode lead wire and the negative electrode lead wire are pressed by atmospheric pressure. When the secondary battery is charged in this state, and thus the thickness of the negative electrode layer is increased, the functions of the extra length portions of the positive electrode lead wire and the negative electrode lead wire are not sufficiently achieved, and thus an excessive tensile load is applied between the positive electrode lead wire and a positive electrode tab and between the negative electrode lead wire and a negative electrode tab, with the result that the positive electrode lead wire and the negative electrode lead wire may be cut. When the secondary battery is manufactured, it is likely that an extra length is changed by the position of an electrode multilayer arranged in the recess portion of the cup-shaped formed member, and thus the functions of the extra length portions are unstable. Furthermore, when the position of the electrode multilayer is moved by conveyance or the like during the manufacturing process of the secondary battery, it is likely that a sufficient extra length is not provided, and thus the functions of the extra length portions are unstable.

The present invention is made in view of the foregoing, and an object of the present invention is to provide a secondary battery and a method for manufacturing the secondary battery in which even when a large change in the thickness of a negative electrode layer is caused, a positive electrode lead wire and a negative electrode lead wire are unlikely to be cut, and thus it is possible to obtain stable charging/discharging characteristics. Then, this contributes to an increase in energy efficiency.

In order to solve the problems described above, the present inventor has found the following configuration effective: in the configuration, the recess portion of a cup-shaped formed member is divided into an electrode multilayer container for containing an electrode multilayer, a positive electrode lead wire container for containing a positive electrode lead wire and a negative electrode lead wire container for containing a negative electrode lead wire; the widths of the positive electrode lead wire container and the negative electrode lead wire container are made narrower than the width of the electrode multilayer; locating members are provided in a positive electrode tab and a negative electrode tab; and the positive electrode tab and the negative electrode tab are arranged in predetermined positions, with the result that the present inventor has achieved the present invention. Hence, the present invention provides the followings.

(1) A secondary battery including: an electrode multilayer that includes a positive electrode layer, a negative electrode layer and a separator arranged between the positive electrode layer and the negative electrode layer; an exterior case; a positive electrode tab and a negative electrode tab that are included in the exterior case; a positive electrode lead wire that electrically connects the positive electrode layer and the positive electrode tab; and a negative electrode lead wire that electrically connects the negative electrode layer and the negative electrode tab, in which the exterior case includes a cup-shaped formed member, the cup-shaped formed member includes a recess portion and a flat portion that is connected to an edge of the recess portion, the recess portion includes an electrode multilayer container that contains the electrode multilayer, a positive electrode lead wire container that contains the positive electrode lead wire and a negative electrode lead wire container that contains the negative electrode lead wire, the width of the positive electrode lead wire container and the width of the negative electrode lead wire container are narrower than the width of the electrode multilayer, the positive electrode tab includes a positive electrode tab locating member, and the positive electrode tab locating member and an edge of the positive electrode lead wire container are in contact with each other in at least two locations, the negative electrode tab includes a negative electrode tab locating member, and the negative electrode tab locating member and an edge of the negative electrode lead wire container are in contact with each other in at least two locations, the length of the positive electrode lead wire is longer than a distance between the positive electrode layer and the positive electrode tab, and the length of the negative electrode lead wire is longer than a distance between the negative electrode layer and the negative electrode tab.

In the secondary battery of (1), the recess portion of the cup-shaped formed member includes the electrode multilayer container, the positive electrode lead wire container and the negative electrode lead wire container, the widths of the positive electrode lead wire container and the width of the negative electrode lead wire container are narrower than the width of the electrode multilayer and thus the strength of the positive electrode lead wire container and the negative electrode lead wire container is increased. Hence, by decompression sealing when the secondary battery is manufactured, the positive electrode lead wire container and the negative electrode lead wire container are unlikely to be excessively deformed, and the positive electrode lead wire and the negative electrode lead wire are unlikely to be pressed by atmospheric pressure. In this way, the functions of the extra length portion (portion of a length obtained by subtracting a distance between the positive electrode layer and the positive electrode tab from the length of the positive electrode lead wire) of the positive electrode lead wire and the extra length portion (portion of a length obtained by subtracting a distance between the negative electrode layer and the negative electrode tab from the length of the negative electrode lead wire) of the negative electrode lead wire are unlikely to be impaired. The electrode multilayer is fixed in the electrode multilayer container, the positive electrode tab is fixed by the positive electrode tab locating member, the negative electrode tab is fixed by the negative electrode tab locating member and thus the positions of the positive electrode lead wire and the negative electrode lead wire are stable, with the result that it is possible to cause the extra length portions of the positive electrode lead wire and the negative electrode lead wire to function stably.

(2) In the secondary battery described in (1) above, the positive electrode lead wire container and the negative electrode lead wire container are curved in a top view.

In the secondary battery of (2), the positive electrode lead wire container and the negative electrode lead wire container are curved in a top view, and thus the spaces of the positive electrode lead wire container and the negative electrode lead wire container can be increased, with the result that it is possible to alleviate a pressing force of the atmosphere caused by decompression sealing when the secondary battery is manufactured.

(3) The secondary battery described in (1) above, in which the positive electrode lead wire container and the negative electrode lead wire container are polygonal in a top view.

In the secondary battery of (3), the positive electrode lead wire container and the negative electrode lead wire container are polygonal in a top view, and thus the areas of the side surfaces thereof are increased as compared with the case where the positive electrode lead wire container and the negative electrode lead wire container are curved in a top view, with the result that the thicknesses thereof are decreased. Hence, creases are easily generated in the positive electrode lead wire container and the negative electrode lead wire container by decompression sealing when the secondary battery is manufactured. Hence, in the secondary battery of (3), a large number of creases are generated in the side surfaces of the positive electrode lead wire container and the negative electrode lead wire container, the creases function as columns and thus spaces are secured in the vicinity of the positive electrode lead wire and the negative electrode lead wire, with the result that the pressing of the positive electrode lead wire and the negative electrode lead wire caused by atmospheric pressure is alleviated.

(4) The secondary battery described in any one of (1) to (3) above, in which the length of the positive electrode tab locating member is longer than an extra length of the positive electrode lead wire obtained by subtracting the distance between the positive electrode layer and the positive electrode tab from the length of the positive electrode lead wire, and the length of the negative electrode tab locating member is longer than an extra length of the negative electrode lead wire obtained by subtracting the distance between the negative electrode layer and the negative electrode tab from the length of the negative electrode lead wire.

In the secondary battery of (4), the length of the positive electrode tab locating member is longer than the extra length of the positive electrode lead wire, and the length of the negative electrode tab locating member is longer than the extra length of the negative electrode lead wire, with the result that even when the rigidity of the cup-shaped formed member is low, the positive electrode tab and the negative electrode tab are easily located.

(5) The lithium metal secondary battery described in any one of (1) to (4) above, in which the electrode multilayer is rectangular in a top view, and the positive electrode tab locating member and the negative electrode tab locating member are arranged to sandwich the electrode multilayer on a center line of two opposite sides of the electrode multilayer.

In the secondary battery of (5), the positive electrode tab locating member and the negative electrode tab locating member are on the center line of two opposite sides of the electrode multilayer, and thus the positive electrode tab and the negative electrode tab are easily located, with the result that labor-saving during manufacturing can be achieved.

(6) The lithium metal secondary battery described in any one of (1) to (5) above, in which a negative electrode active material is metallic lithium.

In the secondary battery of (6), the negative electrode active material is metallic lithium, and thus it is possible to increase the capacity thereof.

(7) A method for manufacturing a secondary battery including: preparing a cup-shaped formed member that includes: an electrode multilayer that includes a positive electrode layer, a negative electrode layer, and a separator arranged between the positive electrode layer and the negative electrode layer; a recess portion; and a flat portion that is connected to an edge of the recess portion, in which the recess portion includes an electrode multilayer container, a positive electrode lead wire container and a negative electrode lead wire container and in which the width of the positive electrode lead wire container and the width of the negative electrode lead wire container are narrower than the width of the electrode multilayer; connecting a positive electrode tab to the positive electrode layer of the electrode multilayer via a positive electrode lead wire that is longer than a distance between the positive electrode layer and the positive electrode tab, and connecting a negative electrode tab to the negative electrode layer via a negative electrode lead wire that is longer than a distance between the negative electrode layer and the negative electrode tab; attaching a positive electrode tab locating member to the positive electrode tab, and attaching a negative electrode tab locating member to the negative electrode tab; containing the electrode multilayer in the electrode multilayer container of the cup-shaped formed member, containing the positive electrode lead wire in the positive electrode lead wire container, and containing the negative electrode lead wire in the negative electrode lead wire container; and fixing the positive electrode tab such that the positive electrode tab locating member of the positive electrode tab and an edge of the positive electrode lead wire container are in contact with each other in at least two locations, and fixing the negative electrode tab such that the negative electrode tab locating member of the negative electrode tab and an edge of the negative electrode lead wire container are in contact with each other in at least two locations.

In the method for manufacturing a secondary battery of (7), the recess portion of the cup-shaped formed member includes the electrode multilayer container, the positive electrode lead wire container, and the negative electrode lead wire container, the widths of the positive electrode lead wire container and the width of the negative electrode lead wire container are narrower than the width of the electrode multilayer and thus the electrode multilayer, the positive electrode lead wire and the negative electrode layer can be arranged in predetermined positions accurately and easily, with the result that the electrode multilayer arranged is unlikely to be moved. The positive electrode tab is fixed by the positive electrode tab locating member, the negative electrode tab is fixed by the negative electrode tab locating member and thus the positive electrode tab and the negative electrode tab can be arranged easily and accurately, with the result that the positive electrode tab and the negative electrode tab arranged are unlikely to be moved. Hence, in the secondary battery obtained, the positions of the positive electrode lead wire and the negative electrode lead wire are stable, enabling the extra length portion to function stably. Hence, in the manufacturing method of (7), it is possible to industrially advantageously manufacture the secondary battery in which even when a large change in the thickness of the negative electrode layer is caused, the positive electrode lead wire and the negative electrode lead wire are unlikely to be cut, and thus charging/discharging characteristics are stable.

According to the present invention, it is possible to provide a secondary battery and a method for manufacturing the secondary battery in which even when a large change in the thickness of a negative electrode layer is caused, a positive electrode lead wire and a negative electrode lead wire are unlikely to be cut, and thus it is possible to obtain stable charging/discharging characteristics.

### BRIEF DESCRIPTION OF THE DRAWINGS

FIG. 1 is a perspective view of a secondary battery according to an embodiment of the present invention;

FIG. 2 is a plan view when the positive electrode lead wire container of the secondary battery shown in FIG. 1 is viewed from above;

FIG. 3 is a cross-sectional view taken along line III-III in FIG. 1;

FIG. 4 is a cross-sectional view taken along line IV-IV in FIG. 1;

FIG. 5 is a perspective view of a secondary battery according to an embodiment of the present invention; and

FIG. 6 is a plan view when the positive electrode lead wire container of the secondary battery shown in FIG. 5 is viewed from above.

### DETAILED DESCRIPTION OF THE INVENTION

Embodiments of the present invention will be described below with reference to drawings. However, the embodiments described below illustrate the present invention, and the present invention is not limited to the following embodiments.

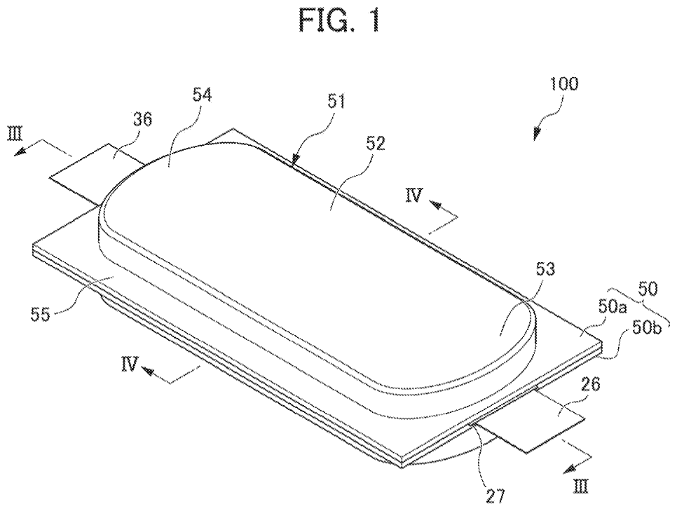

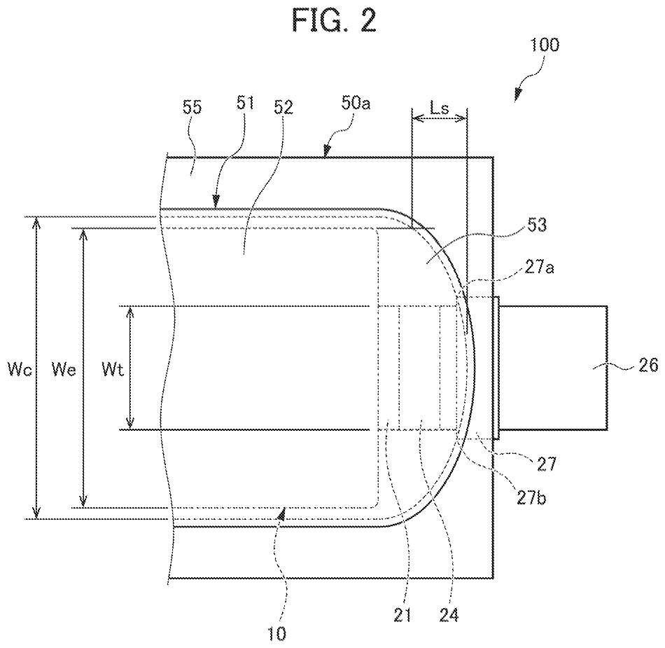

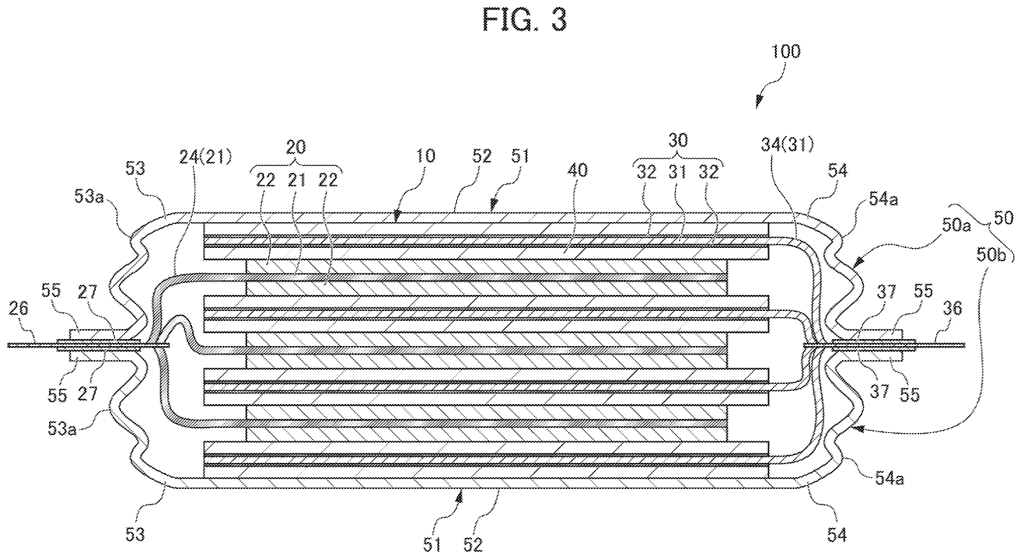

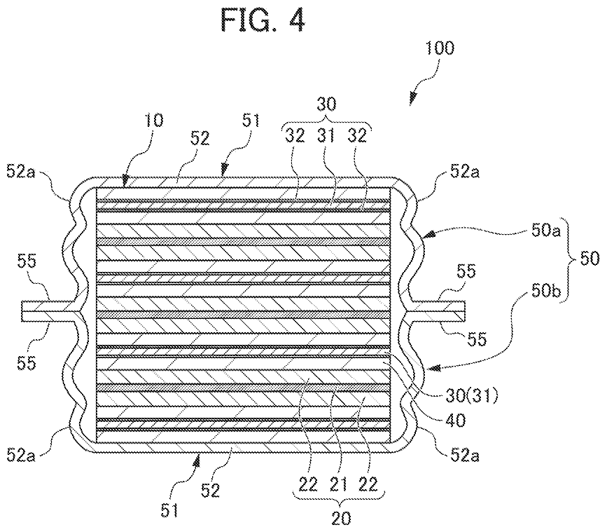

FIG. 1 is a perspective view of a secondary battery according to an embodiment of the present invention. FIG. 2 is a plan view when the positive electrode lead wire container of the secondary battery shown in FIG. 1 is viewed from above, FIG. 3 is a cross-sectional view taken along line III-III in FIG. 1 and FIG. 4 is a cross-sectional view taken along line IV-IV in FIG. 1.

The secondary battery 100 of the present embodiment includes: an electrode multilayer 10 which includes a positive electrode layer 20, a negative electrode layer 30 and a separator 40 arranged between the positive electrode layer 20 and the negative electrode layer 30; an electrolyte solution (not shown); an exterior case 50; a positive electrode tab 26 and a negative electrode tab 36 included in the exterior case 50; a positive electrode lead wire 24 which electrically connects the positive electrode layer 20 and the positive electrode tab 26; and a negative electrode lead wire 34 which electrically connects the negative electrode layer 30 and the negative electrode tab 36. The electrode multilayer 10 is rectangular in a top view.

The positive electrode layer 20 includes a positive electrode current collector 21 and positive electrode active material layers 22 which are stacked on both surfaces of the positive electrode current collector 21. The positive electrode lead wire 24 is connected to the positive electrode current collector 21 of the positive electrode layer 20. The negative electrode layer 30 includes a negative electrode current collector 31 and lithium foil 32 which is stacked on both surfaces of the negative electrode current collector 31. The negative electrode lead wire 34 is connected to the negative electrode current collector 31 of the negative electrode layer 30. The secondary battery 100 is a lithium metal secondary battery. The lithium metal secondary battery is a secondary battery in which metallic lithium is used as a negative electrode active material, lithium is released from the positive electrode active material layer 22 during charging, the lithium is precipitated on the surface of the lithium foil 32 and thus a metallic lithium layer is generated. Hence, the thickness of the negative electrode layer 30 is increased during charging. On the other hand, during discharging, lithium is released from the metallic lithium layer and is absorbed in the positive electrode active material layer. Hence, the thickness of the negative electrode layer 30 is reduced during discharging. Therefore, in the negative electrode layer 30, a large change in the thickness is caused by charging and discharging. The secondary battery 100 shown in FIGS. 1 to 4 is in a discharged state.

The length of the positive electrode lead wire 24 is longer than a distance between the positive electrode layer 20 (positive electrode current collector 21) and the positive electrode tab 26, and the positive electrode lead wire 24 includes an extra length portion. The length (extra length) of the extra length portion is a length which is obtained by subtracting the distance between the positive electrode layer 20 and the positive electrode tab 26 from the length of the negative electrode lead wire 24. The positive electrode lead wire 24 includes the extra length portion, and thus the positive electrode lead wire 24 is unlikely to be cut by tensile stress caused by a change in the thickness of the negative electrode layer 30 due to charging and discharging. The width Wt of the positive electrode lead wire 24 is narrower than the width We of the electrode multilayer 10 as shown in FIG. 2. The length of the negative electrode lead wire 34 is longer than a distance between the negative electrode layer 30 (negative electrode current collector 31) and the negative electrode tab 36, and the negative electrode lead wire 34 includes an extra length portion. The length of the extra length portion is a length which is obtained by subtracting the distance between the negative electrode layer 30 and the negative electrode tab 36 from the length of the negative electrode lead wire 34.

The positive electrode tab 26 includes a positive electrode tab locating member 27, and the negative electrode tab 36 includes a negative electrode tab locating member 37.

The exterior case 50 is formed by overlaying a first cup-shaped formed member 50a and a second cup-shaped formed member 50b on each other such that recess portions 51 face outward. Each of the first cup-shaped formed member 50a and the second cup-shaped formed member 50b includes the recess portion 51 and a flat portion 55 which is connected to an edge of the recess portion 51. The recess portion 51 includes an electrode multilayer container 52 which contains the electrode multilayer 10, a positive electrode lead wire container 53 which contains the positive electrode lead wire 24 and a negative electrode lead wire container 54 which contains the negative electrode lead wire 34.

The size of the electrode multilayer container 52 is not particularly limited as long as the electrode multilayer 10 can be contained. As shown in FIG. 2, the width Wc of the electrode multilayer container 52 may be slightly wider than the width We of the electrode multilayer 10. The electrode multilayer container 52 is rectangular in a top view, and creases are easily generated by decompression sealing when the secondary battery 100 is manufactured. Hence, as shown in FIG. 4, by decompression sealing when the secondary battery 100 is manufactured, creases 52a are formed in the top and side surfaces of the electrode multilayer container 52. The creases 52a function as columns to increase the strength of the electrode multilayer container 52. When the thickness of the negative electrode layer 30 is increased by charging, the creases 52a are extended, and thus the volume of the electrode multilayer container 52 is increased.

The widths of the positive electrode lead wire container 53 and the negative electrode lead wire container 54 are narrower than the width Wc of the electrode multilayer container 52. In this way, the electrode multilayer 10 is unlikely to enter the positive electrode lead wire container 53 and the negative electrode lead wire container 54, and thus the electrode multilayer 10 is fixed in the electrode multilayer container 52.

The positive electrode lead wire container 53 and the negative electrode lead wire container 54 are curved in a top view. The positive electrode lead wire container 53 and the negative electrode lead wire 34 are arcs, and are formed such that the lengths thereof at the centers in the width direction are longest. The longest length Ls of the positive electrode lead wire container 53 is not particularly limited as long as the positive electrode lead wire 24 can be contained (see FIG. 2). The longest length of the negative electrode lead wire container 54 is also not particularly limited as long as the negative electrode lead wire 34 can be contained.

Since the positive electrode lead wire container 53 and the negative electrode lead wire container 54 are in the shape of an arc, the spaces of the positive electrode lead wire container 53 and the negative electrode lead wire container 54 can be increased, and thus it is possible to alleviate a pressing force of the atmosphere caused by decompression sealing. Furthermore, since the positive electrode lead wire container 53 and the negative electrode lead wire container 54 are in the shape of an arc, and there is no angular part like the apex of a cube, partial deformation of the tops thereof are unlikely to be caused by decompression sealing when the secondary battery 100 is manufactured. Hence, as shown in FIG. 3, by decompression sealing when the secondary battery 100 is manufactured, creases 53a are uniformly formed in the side surface of the positive electrode lead wire container 53, and creases 54a are uniformly formed in the side surface of the negative electrode lead wire container 54. The creases 53a and 54a function as columns, and thus spaces are secured in the vicinity of the positive electrode lead wire container 53 and the negative electrode lead wire container 54. When the thickness of the negative electrode layer 30 is increased by charging, the creases 53a and 54a are extended, and thus the volumes of the positive electrode lead wire container 53 and the negative electrode lead wire container 54 are increased.

The positive electrode tab 26 is located by the positive electrode tab locating member 27 and the positive electrode lead wire container 53. As shown in FIG. 2, corners 27a and 27b of the positive electrode tab locating member 27 are in contact with an edge of the positive electrode lead wire container 53, and thus the positive electrode tab 26 is located. Likewise, the negative electrode tab 36 is located by the negative electrode tab locating member 37 and the negative electrode lead wire container 54.

The positive electrode tab locating member 27 and the negative electrode tab locating member 37 are arranged to sandwich the electrode multilayer 10 on a center line of two opposite sides of the electrode multilayer 10. The positive electrode tab locating member 27 and the negative electrode tab locating member 37 are on the center line of two opposite sides of the electrode multilayer 10, and thus the positive electrode tab 26 and the negative electrode tab 36 are easily located, with the result that labor-saving during manufacturing can be achieved.

The width of the positive electrode tab locating member 27 is wider than the width of the positive electrode lead wire 24. The width of the negative electrode tab locating member 37 is longer than the length of the extra length portion of the negative electrode lead wire 34. For example, when the width Wt of the positive electrode lead wire 24 and the negative electrode lead wire 34 is 50 mm, the length of the extra length portions of the positive electrode lead wire 24 and the negative electrode lead wire 34 may be 1 to 2 mm, and the widths of the positive electrode tab locating member 27 and the negative electrode tab locating member 37 (lengths in a direction orthogonal to a direction in which the positive electrode lead wire 24 and the negative electrode lead wire 34 extend) may be 54 mm. When the widths of the positive electrode tab locating member 27 and the negative electrode tab locating member 37 are wide, even if the rigidity of the first cup-shaped formed member 50a and the second cup-shaped formed member 50b are low, the positive electrode tab 26 and the negative electrode tab 36 are easily located.

The material of the positive electrode current collector 21 is not particularly limited, and for example, aluminum can be used.

The positive electrode active material layer 22 includes a positive electrode active material. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}COᵣO_{z} (p+q+r=1), lithium manganate (LiMn₂O₄), a different element substituted Li—Mn spinel represented by Li₁₊ₓMn_{2-x-y}M_{y}O₄ (x+y=2, M=at least one selected from Al, Mg, Co, Fe, Ni and Zn), lithium titanate (oxide including Li and Ti), lithium metal phosphate (LiMPO₄, M=at least one selected from Fe, Mn, Co and Ni) and the like. The positive electrode active material layer 22 may include various types of additives which are used as the materials of the positive electrode active material such as a binder and a conductive aid.

The material of the positive electrode lead wire 24 may be the same as the material of the positive electrode current collector 21 or may be different from the material of the positive electrode current collector 21. The positive electrode lead wire 24 may be integrally connected to the positive electrode current collector 21. In the present embodiment, the positive electrode lead wire 24 is formed by extending the positive electrode current collector 21 and is integrally connected to the positive electrode current collector 21. The material of the positive electrode tab 26 may be the same as the material of the positive electrode lead wire 24 or may be different from the material of the positive electrode lead wire 24. The positive electrode tab 26 may be integrally connected to the positive electrode lead wire 24. In the present embodiment, the positive electrode tab 26 and the positive electrode lead wire 24 are separate members, and are electrically connected. As the material of the positive electrode tab locating member 27, for example, a thermoplastic resin such as polyethylene terephthalate (PET), polyamide (nylon) or polypropylene (PP) can be used.

The material of the negative electrode current collector 31 is not particularly limited, and for example, copper can be used. The material of the negative electrode lead wire 34 may be the same as the material of the negative electrode current collector 31 or may be different from the material of the negative electrode current collector 31. The negative electrode lead wire 34 may be integrally connected to the negative electrode current collector 31. In the present embodiment, the negative electrode lead wire 34 is formed by extending the negative electrode current collector 31 and is integrally connected to the negative electrode current collector 31. The material of the negative electrode tab 36 may be the same as the material of the negative electrode lead wire 34 or may be different from the material of the negative electrode lead wire 34. The negative electrode tab 36 may be integrally connected to the negative electrode lead wire 34. In the present embodiment, the negative electrode tab 36 and the negative electrode lead wire 34 are separate members, and are electrically connected. As the material of the negative electrode tab locating member 37, for example, a thermoplastic resin such as polyethylene terephthalate (PET), polyamide (nylon) or polypropylene (PP) can be used.

As the separator 40, for example, known separators such as a porous sheet and a nonwoven sheet which are used as separators for secondary batteries can be used. Examples of the material of the porous sheet include polyolefins such as polyethylene and polypropylene, aramid, polyimide, fluororesin and the like. Examples of the material of the nonwoven sheet include glass fiber, cellulose fiber and the like.

The electrolyte solution includes an organic solvent and an electrolyte. Examples of the organic solvent which can be used include cyclic carbonate, chain carbonate, cyclic ether, chain ether, hydrofluoroether, aromatic ether, sulfone, cyclic ester, chain carboxylic acid ester and nitrile. Examples of the cyclic carbonate include ethylene carbonate, propylene carbonate, vinylene carbonate, fluoroethylene carbonate and the like. Examples of the chain carbonate include dimethyl carbonate, diethyl carbonate, ethyl methyl carbonate and the like. Examples of the cyclic ether include tetrahydrofuran, 2-methyltetrahydrofuran, tetrahydropyran, 1,3-dioxolane, 4-methyl-1,3-dioxolane and the like. Examples of the chain ether include 1,2-dimethoxyethane, 1,2-diethoxyethane, ethoxymethoxyethane, diethyl ether and the like. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,2-bis(1,1,2,2-tetrafluoroethoxy) ethane and the like. Examples of the aromatic ether include anisole. Examples of the sulfone include sulfolane, methylsulfolane and the like. Examples of the cyclic ester include γ-butyrolactone and the like. Examples of the chain carboxylic acid ester include acetate ester, butyrate ester, propionate ester and the like. Examples of the nitrile include acetonitrile, propionitrile and the like. As the organic solvent, one type may be used singly or two or more types may be combined to be used.

The electrolyte is the supply source of lithium ions which are charge transfer media, and contains a lithium salt. Examples of the lithium salt include LiPF₆, LiBF₄, LiC₁₀₄, LiAsF₆, LiCF₃SO₃, Lic (CF₃SO₂)₃, LIN (CF₃SO₂)₂ (LiTFSI), LiN(FSO₂)₂ (LiFSI), LiBC₄O₈ and the like. As the lithium salt, one type may be used singly or two or more types may be combined to be used. The concentration of the electrolyte is, for example, in a range of 1.5 to 4.0 mol/L.

The first cup-shaped formed member 50a and the second cup-shaped formed member 50b of the exterior case 50 can be expanded and contracted according to a change in the thickness of the negative electrode layer 30. As the material of the first cup-shaped formed member 50a and the second cup-shaped formed member 50b, a laminate material can be used. As the laminate material, a multilayer film of a three-layer structure in which an inner resin layer, a metal layer and an outer resin layer are stacked in this order from the inside. As the material of the inner resin layer and the outer resin layer, for example, a thermoplastic resin such as polyethylene terephthalate (PET), polyamide (nylon) or polypropylene (PP) can be used. As the material of the metal layer, for example, aluminum can be used.

The secondary battery of the present invention can be manufactured by a method which includes, for example, preparing, connecting tabs, attaching tab locating members, containing, locating tabs and sealing.

The preparing is preparing the electrode multilayer 10, the first cup-shaped formed member 50a and the second cup-shaped formed member 50b. The electrode multilayer 10 can be obtained by stacking, for example, the positive electrode layer 20, the separator 40 and the negative electrode layer 30 in this order. The first cup-shaped formed member 50a and the second cup-shaped formed member 50b can be obtained by, for example, drawing a laminate material.

The connecting of tabs is connecting the positive electrode tab 26 and the negative electrode tab 36 to the electrode multilayer 10. Specifically, the positive electrode tab 26 is connected to the positive electrode layer 20 (positive electrode current collector 21) of the electrode multilayer 10 via the positive electrode lead wire 24, and the negative electrode tab 36 is connected to the negative electrode layer 30 (negative electrode current collector 31) via the negative electrode lead wire 34. The attaching of tab locating members is attaching the positive electrode tab locating member 27 to the positive electrode tab 26 and attaching the negative electrode tab locating member 37 to the negative electrode tab 36. The order of the connecting of tabs and the attaching of tab locating members is not particularly limited. After the connecting of tabs, the positive electrode tab locating member 27 and the negative electrode tab locating member 37 may be attached to the positive electrode tab 26 and the negative electrode tab 36 connected to the electrode multilayer 10. After the attaching of tab locating members, the positive electrode tab 26 to which the positive electrode tab locating member 27 has been attached and the negative electrode tab 36 to which the negative electrode tab locating member 37 has been attached may be connected to the electrode multilayer 10.

The containing is containing the electrode multilayer 10 with the tabs obtained by performing the connecting of tabs and the attaching of tab locating members and the electrolyte solution (not shown) in the second cup-shaped formed member 50b prepared by the preparing. Specifically, the electrode multilayer 10 is contained in the electrode multilayer container 52 of the second cup-shaped formed member 50b, the positive electrode lead wire 24 is contained in the positive electrode lead wire container 53 and the negative electrode lead wire 34 is contained in the negative electrode lead wire container 54.

The locating of tabs is locating and fixing the positions of the positive electrode tab 26 and the negative electrode tab 36 connected to the electrode multilayer 10. Specifically, the positive electrode tab 26 is fixed such that the corners 27a and 27b of the positive electrode tab locating member 27 of the positive electrode tab 26 and the edge of the positive electrode lead wire container 53 are in contact with each other. As with the positive electrode tab 26, the negative electrode tab 36 is fixed such that the negative electrode tab locating member 37 and an edge of the negative electrode lead wire container 54 are in contact with each other in two locations at corners of the negative electrode tab locating member 37.

The sealing is hermetically sealing the recess portion 51 of the second cup-shaped formed member 50b. Specifically, first, the recess portion 51 of the second cup-shaped formed member 50b and the recess portion 51 of the first cup-shaped formed member 50a are overlaid on each other such that the recess portions 51 face outward, and thus three sides out of the four sides of the flat portion 55 of the first cup-shaped formed member 50a and the flat portion 55 of the second cup-shaped formed member 50b are sealed. Then, after the electrolyte solution is poured into the recess portions 51, the remaining one side of the flat portion 55 is sealed while the interior of the recess portions 51 is being decompressed. The sealing can be performed by heating and fusing the flat portion 55 of the first cup-shaped formed member 50a and the flat portion 55 of the second cup-shaped formed member 50b. The decompression sealing is performed because the secondary battery 100 is prevented from being expanded when the secondary battery 100 is placed in an environment below atmospheric pressure due to, for example, air transportation or use of the secondary battery 100 at high altitudes.

In the secondary battery 100 of the present embodiment configured as described above, the recess portion 51 of each of the first cup-shaped formed member 50a and the second cup-shaped formed member 50b includes the electrode multilayer container 52, the positive electrode lead wire container 53 and the negative electrode lead wire container 54, the width of the positive electrode lead wire container 53 and the width of the negative electrode lead wire container 54 are narrower than the width of the electrode multilayer 10 and thus the strength of the positive electrode lead wire container 53 and the negative electrode lead wire container 54 is increased. Hence, by decompression sealing when the secondary battery 100 is manufactured, the positive electrode lead wire container 53 and the negative electrode lead wire container 54 are unlikely to be excessively deformed, and the positive electrode lead wire 24 and the negative electrode lead wire 34 are unlikely to be pressed by atmospheric pressure. In this way, the functions of the extra length portion of the positive electrode lead wire 24 and the extra length portion of the negative electrode lead wire 34 are unlikely to be impaired. The electrode multilayer 10 is fixed in the electrode multilayer container 51, the positive electrode tab 26 is fixed by the positive electrode tab locating member 27, the negative electrode tab 36 is fixed by the negative electrode tab locating member 37 and thus the positions of the positive electrode lead wire 24 and the negative electrode lead wire 34 are stable. Hence, it is possible to cause the extra length portions of the positive electrode lead wire and the negative electrode lead wire to function stably. Therefore, in the secondary battery 100 of the present embodiment, even when a large change in the thickness of the negative electrode layer 30 is caused, the positive electrode lead wire 24 and the negative electrode lead wire 34 are unlikely to be cut, and thus it is possible to obtain stable charging/discharging characteristics.

In the secondary battery 100 of the present embodiment, the positive electrode lead wire container 53 and the negative electrode lead wire container 54 are in the shape of an arc in a top view, and thus the spaces of the positive electrode lead wire container 53 and the negative electrode lead wire container 54 can be increased, with the result that it is possible to alleviate a pressing force of the atmosphere caused by decompression sealing when the secondary battery 100 is manufactured. The positive electrode lead wire container 53 and the negative electrode lead wire container 54 include no angular tops. Hence, by decompression sealing when the secondary battery 100 is manufactured, uniform creases 53a and 54b are easily formed along the side surfaces of the positive electrode lead wire container 53 and the negative electrode lead wire container 54. The positive electrode lead wire container 53 and the negative electrode lead wire container 54 include no corners, and thus the thicknesses thereof are more likely to be uniform. The thicknesses of the positive electrode lead wire container 53 and the negative electrode lead wire container 54 are uniform, and thus pinholes are formed, with the result that failures such as the leakage of the electrolyte solution, the intrusion of water and insulation breakdown are unlikely to occur. It is also possible to increase the strength of the entire recess portions 51, to enhance the sealing property, to increase the depth of the recess portions 51, to increase the thickness of the electrode multilayer 10 contained in the recess portions 51 and to further increase the capacity of the secondary battery 100. The shapes of the positive electrode lead wire container 53 and the negative electrode lead wire container 54 are not limited to arcs, and the shapes are preferably curved in a top view.

In the method for manufacturing the secondary battery 100 of the present embodiment, the recess portion 51 of each of the first cup-shaped formed member 50a and the second cup-shaped formed member 50b includes the electrode multilayer container 52, the positive electrode lead wire container 53 and the negative electrode lead wire container 54, the widths of the positive electrode lead wire container 53 and the width of the negative electrode lead wire container 54 are narrower than the width of the electrode multilayer 10 and thus the electrode multilayer 10, the positive electrode lead wire 24 and the negative electrode layer 34 can be arranged in predetermined positions accurately and easily, with the result that the electrode multilayer 10 arranged is unlikely to be moved. The positive electrode tab 26 is fixed by the positive electrode tab locating member 27, the negative electrode tab 36 is fixed by the negative electrode tab locating member 37 and thus the positive electrode tab 26 and the negative electrode tab 36 can be arranged accurately and easily, with the result that the positive electrode tab and the negative electrode tab arranged are unlikely to be moved. Hence, in the secondary battery 100 obtained, the positions of the positive electrode lead wire 24 and the negative electrode lead wire 34 are stable, and thus the extra length portions can be caused to function stably. Therefore, in the method for manufacturing the secondary battery 100 of the present embodiment, it is possible to industrially advantageously manufacture the secondary battery 100 in which even when a large change in the thickness of the negative electrode layer 30 is caused, the positive electrode lead wire 24 and the negative electrode lead wire 34 are unlikely to be cut, and thus charging/discharging characteristics are stable.

Although the preferred embodiment of the present invention has been described above, the present invention is not limited to the embodiment described above, and modifications can be made as necessary. For example, although in the secondary battery 100 of the present embodiment, the exterior case 50 is formed by overlaying the first cup-shaped formed member 50a and the second cup-shaped formed member 50b on each other, the configuration of the exterior case 50 is not limited to this configuration. Either of the first cup-shaped formed member 50a and the second cup-shaped formed member 50b may be replaced with a flat sheet.

Although the secondary battery 100 of the present embodiment uses metallic lithium as the negative electrode active material, the negative electrode active material is not limited to metallic lithium. As the negative electrode active material, a layer may be used which includes a negative electrode active material that absorbs lithium during charging and releases lithium during discharging. Examples of the negative electrode active material as described above which can be used include lithium transition metal oxides such as lithium titanate, transition metal oxides such as TiO₂, Nb₂O₃ and WO₃, SiO, metal sulfides, metal nitrides and carbon materials such as artificial graphite, natural graphite, graphite, soft carbon and hard carbon. As the negative electrode active material, a metal which forms an alloy with lithium can be used. Examples of the metal which forms an alloy with lithium include Mg, Si, Au, Ag, In, Ge, Sn, Pb, Al, Zn and the like.

Furthermore, although the secondary battery 100 of the present embodiment uses the electrolyte solution as the electrolyte, the electrolyte is not limited to the electrolyte solution. For example, as the electrolyte, a solid electrolyte may be used. Examples of the solid electrolyte which can be used include a sulfide solid electrolyte, an oxide solid electrolyte, a nitride solid electrolyte, a halide solid electrolyte and the like. Examples of the sulfide solid electrolyte include Li₂S—P₂S₅, Li₂S—P₂S₅—LiI and the like. Examples of the oxide solid electrolyte include a NASICON type oxide, a garnet type oxide, a perovskite type oxide and the like. Examples of the NASICON type oxide include oxides containing Li, Al, Ti, P and O (for example, Li_{1.5}Al_{0.5}Ti_{1.5}(PO₄)₃). Examples of the garnet type oxide include oxides containing Li, La, Zr and O (for example, Li₇La₃Zr₂O₁₂). Examples of the perovskite type oxide include oxides containing Li, La, Ti and O (for example, LiLaTiO₃).

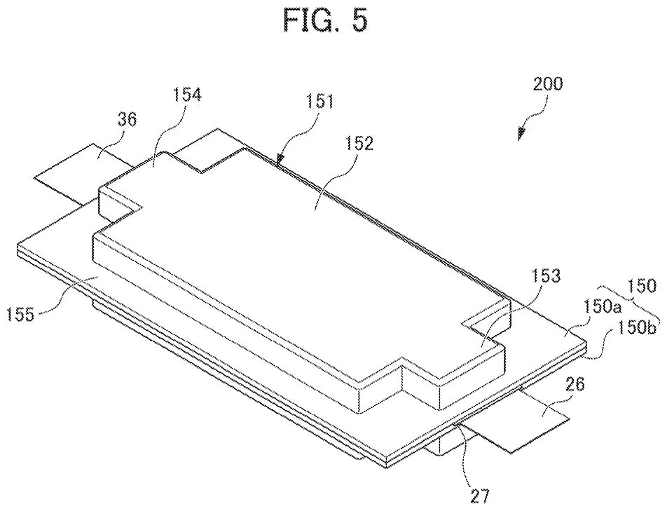

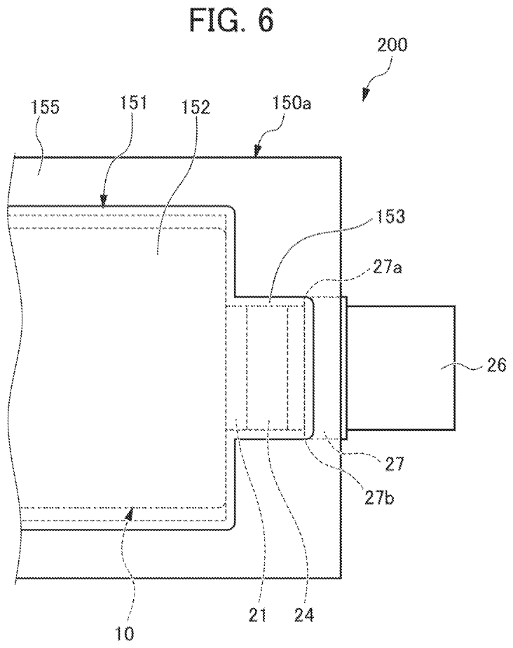

Furthermore, although in the secondary battery 100 of the present embodiment, the positive electrode lead wire container 53 and the negative electrode lead wire container 54 are curved in a top view, the shapes of the positive electrode lead wire container 53 and the negative electrode lead wire container 54 are not limited to the curved shape. The positive electrode lead wire container 53 and the negative electrode lead wire container 54 are not particularly limited as long as the widths thereof are narrower than the width of the electrode multilayer 10. A variation of the positive electrode lead wire container 53 and the negative electrode lead wire container 54 will then be described with reference to FIGS. 5 and 6.

FIG. 5 is a perspective view of a secondary battery according to another embodiment of the present invention, and FIG. 6 is a plan view when the positive electrode lead wire container of the secondary battery shown in FIG. 5 is viewed from above. In the secondary battery 200 shown in FIGS. 5 and 6, an exterior case 150 is formed by overlaying a first cup-shaped formed member 150a and a second cup-shaped formed member 150b on each other such that recess portions 51 face outward. Each of the first cup-shaped formed member 150a and the second cup-shaped formed member 150b includes a recess portion 151 and a flat portion 155 which is connected to an edge of the recess portion 151. The recess portion 151 includes an electrode multilayer container 152, a positive electrode lead wire container 153 and a negative electrode lead wire container 154. The secondary battery 200 is the same as the secondary battery 100 described previously except that the positive electrode lead wire container 153 and the negative electrode lead wire container 154 are rectangular in a top view. Hence, the same configurations as in the secondary battery 100 are identified with the same reference numerals, and detailed description thereof is omitted.

In the secondary battery 200 of the present embodiment, the widths of the positive electrode lead wire container 153 and the negative electrode lead wire container 154 of the first cup-shaped formed member 150a and the second cup-shaped formed member 150b are narrower than the width of the electrode multilayer 10, and thus the same effects as in the secondary battery 100 are achieved. Since the positive electrode lead wire container 153 and the negative electrode lead wire container 154 are rectangular in a top view, as compared with a case where they are curved in a top view, the areas of the side surfaces thereof are increased, and the thicknesses thereof are decreased. Hence, in the secondary battery 200, by decompression sealing when the secondary battery 200 is manufactured, creases are easily generated in the side surfaces of the positive electrode lead wire container 53 and the negative electrode lead wire container 54. Therefore, in the secondary battery 200, a large number of creases are generated in the side surfaces of the positive electrode lead wire container 53 and the negative electrode lead wire container 54, the creases function as columns and thus spaces are secured in the vicinity of the positive electrode lead wire and the negative electrode lead wire, with the result that the pressing of the positive electrode lead wire and the negative electrode lead wire caused by atmospheric pressure is alleviated. The shapes of the positive electrode lead wire container 153 and the negative electrode lead wire container 154 are not limited to the rectangular shape, and may be a polygonal shape such as a square, a parallelogram, a triangle or a pentagon in a top view.

### EXPLANATION OF REFERENCE NUMERALS

10 electrode multilayer
20 positive electrode layer
21 positive electrode current collector
22 positive electrode active material layer
24 positive electrode lead wire
26 positive electrode tab
27 positive electrode tab locating member
30 negative electrode layer
31 negative electrode current collector
32 lithium foil
34 negative electrode lead wire
36 negative electrode tab
37 negative electrode tab locating member
40 separator
50, 150 exterior case
50a, 150a first cup-shaped formed member
50b, 150b second cup-shaped formed member
51, 151 recess portion
52, 152 electrode multilayer container
53, 153 positive electrode lead wire container
54, 154 negative electrode lead wire container
55, 155 flat portion
100, 200 battery

What is claimed is:

1. A secondary battery comprising: an electrode multilayer that comprises a positive electrode layer, a negative electrode layer and a separator arranged between the positive electrode layer and the negative electrode layer;
an exterior case;
a positive electrode tab and a negative electrode tab that are included in the exterior case;
a positive electrode lead wire that electrically connects the positive electrode layer and the positive electrode tab; and
a negative electrode lead wire that electrically connects the negative electrode layer and the negative electrode tab,
wherein the exterior case comprises a cup-shaped formed member,
the cup-shaped formed member comprises a recess portion and a flat portion that is connected to an edge of the recess portion,
the recess portion comprises an electrode multilayer container that contains the electrode multilayer, a positive electrode lead wire container that contains the positive electrode lead wire and a negative electrode lead wire container that contains the negative electrode lead wire,
a width of the positive electrode lead wire container and a width of the negative electrode lead wire container are narrower than a width of the electrode multilayer,
the positive electrode tab comprises a positive electrode tab locating member, and the positive electrode tab locating member and an edge of the positive electrode lead wire container are in contact with each other in at least two locations,
the negative electrode tab comprises a negative electrode tab locating member, and the negative electrode tab locating member and an edge of the negative electrode lead wire container are in contact with each other in at least two locations,
a length of the positive electrode lead wire is longer than a distance between the positive electrode layer and the positive electrode tab and
a length of the negative electrode lead wire is longer than a distance between the negative electrode layer and the negative electrode tab.

2. The secondary battery according to claim 1, wherein the positive electrode lead wire container and the negative electrode lead wire container are curved in a top view.

3. The secondary battery according to claim 1, wherein the positive electrode lead wire container and the negative electrode lead wire container are polygonal in a top view.

4. The secondary battery according to claim 1, wherein a length of the positive electrode tab locating member is longer than an extra length of the positive electrode lead wire obtained by subtracting the distance between the positive electrode layer and the positive electrode tab from the length of the positive electrode lead wire, and a length of the negative electrode tab locating member is longer than an extra length of the negative electrode lead wire obtained by subtracting the distance between the negative electrode layer and the negative electrode tab from the length of the negative electrode lead wire.

5. The secondary battery according to claim 1, wherein the electrode multilayer is rectangular in a top view, and the positive electrode tab locating member and the negative electrode tab locating member are arranged to sandwich the electrode multilayer on a center line of two opposite sides of the electrode multilayer.

6. The secondary battery according to claim 1, wherein a negative electrode active material is metallic lithium.

7. A method for manufacturing a secondary battery, the method comprising: preparing a cup-shaped formed member that comprises: an electrode multilayer that comprises a positive electrode layer, a negative electrode layer, and a separator arranged between the positive electrode layer and the negative electrode layer; a recess portion; and a flat portion that is connected to an edge of the recess portion, in which the recess portion comprises an electrode multilayer container, a positive electrode lead wire container and a negative electrode lead wire container and in which a width of the positive electrode lead wire container and a width of the negative electrode lead wire container are narrower than a width of the electrode multilayer;
connecting a positive electrode tab to the positive electrode layer of the electrode multilayer via a positive electrode lead wire that is longer than a distance between the positive electrode layer and the positive electrode tab, and connecting a negative electrode tab to the negative electrode layer via a negative electrode lead wire that is longer than a distance between the negative electrode layer and the negative electrode tab;
attaching a positive electrode tab locating member to the positive electrode tab, and attaching a negative electrode tab locating member to the negative electrode tab;
containing the electrode multilayer in the electrode multilayer container of the cup-shaped formed member, containing the positive electrode lead wire in the positive electrode lead wire container, and containing the negative electrode lead wire in the negative electrode lead wire container; and
fixing the positive electrode tab such that the positive electrode tab locating member of the positive electrode tab and an edge of the positive electrode lead wire container are in contact with each other in at least two locations, and fixing the negative electrode tab such that the negative electrode tab locating member of the negative electrode tab and an edge of the negative electrode lead wire container are in contact with each other in at least two locations.
